(19) United States
(12) Patent Application Publication
(10) Pub. No.: US 2008/0104094 A1
(43) Pub. Date: May 1, 2008

(54) Systems and methods for managing syslog messages

(76) Inventors: Adrian Cowham, Roseville, CA (US); Neeshant D. Desai, Auburn, CA (US); Devon L. Dawson, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,142

(22) Filed: Oct. 31, 2006

(51) Int. Cl. G06F 17/00; G06F 17/30

(52) U.S. Cl. 707/101; 707/6

(57) ABSTRACT

In one embodiment, a method for managing syslog messages includes identifying a syslog message format that is not currently accepted, composing a syslog message template that corresponds to the syslog message format, the syslog message template comprising a regular expression having a general arrangement the corresponds to the syslog message format such that validity of future syslog messages can be determined through comparison of the future syslog messages to the regular expression, and storing the syslog message template in a location at which the syslog message template will be considered by a syslog daemon in making a message validity determination.

### CROSS-REFERENCE TO RELATED APPLICATIONS

This application is related to commonly-assigned patent application entitled “Syslog Message Handling” filed on May 25, 2005, and accorded Ser. No. 11/137,885 and “Pattern Matching Algorithm To Determine Valid Syslog Messages” filed on May 25, 2005, and accorded Ser. No. 11/138,530, both of which are entirely incorporated herein by reference.

### BACKGROUND

Syslog is a protocol for forwarding log messages in an Internet protocol (IP) network. Within the syslog protocol, a syslog sender, such as a device or application, sends a small textual message (e.g., less than 1024 bytes) to a syslog receiver, commonly referred to as a syslog daemon, which typically executes on a syslog server.

Syslog messages contain information that may concern any one of a variety of events. For example, a syslog message may be transmitted when a device first logs on to the network, a syslog message may be transmitted when an error occurs, a syslog message may be transmitted when an intruder on the network is detected, a syslog message may be transmitted when a virus is detected, etc.

The syslog messages received by the syslog daemon are normally stored in a message repository such that a record is maintained as to operation of the network and the various devices that it comprises. Such a record is particularly useful when a problem arises. Specifically, when a problem occurs, the record comprises a paper trail of the events that preceded the problem and can be used to determine why the problem occurred and/or how to devise a proactive defense against undesired activity (e.g., network intrusion).

Syslog messages normally comprise a specific format that is dictated by Request for Comments (RFC) 3164. More and more frequently, however, syslog messages are being transmitted that have alternative formats. Currently, syslog messages that do not conform to an expected format are often discarded. Such discarding is performed as a precaution given that certain messages can be detrimental to the system in terms of compromising system security or simply filling the message repository with useless or false information.

The discarding of syslog messages having unexpected formats can be undesirable in some cases. For example, the standard to which syslog messages are to adhere may change over time. Furthermore, even if the official standard does not change, alternative formats may become popular and may therefore come into widespread use. Moreover, even if a particular set of devices or applications use a format that is not widely used, the information provided in syslog messages sent by the devices/applications may still be of high importance to the network and therefore should be retained.

Currently, relatively complicated procedures are used to accommodate new syslog message formats, if at all. In one known technique, a complex parsing algorithm must be modified so that it will recognize the new format(s). Such modification may, however, be beyond the skill of typical network administrators.

### SUMMARY

Disclosed are systems and methods for managing syslog messages. In one embodiment, a method for managing syslog messages includes receiving a syslog message, determining whether the syslog message is valid by comparing the syslog message to one of a plurality of separate syslog message templates to identify whether a format of the syslog message matches a format of the syslog message template, and if the syslog message format does not match the format of the syslog message template, individually comparing the syslog message format with formats of the other syslog message templates until a match is found or it is determined that the syslog message format matches none of the formats of the syslog message templates.

In a further embodiment, a method for managing syslog messages includes identifying a syslog message format that is not currently accepted, composing a syslog message template that corresponds to the syslog message format, the syslog message template comprising a regular expression having a general arrangement the corresponds to the syslog message format such that validity of future syslog messages can be determined through comparison of the future syslog messages to the regular expression, and storing the syslog message template in a location at which the syslog message template will be considered by a syslog daemon in making a message validity determination.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which management of syslog messages can be achieved.

FIG. 2 is a block diagram of an embodiment of a client computer shown in FIG. 1.

FIG. 3 is a block diagram of an embodiment of a server computer shown in FIG. 1.

FIG. 4 is a flow diagram that illustrates an embodiment of a method for managing syslog messages.

FIG. 5 is a flow diagram that illustrates an embodiment of a method for validating a received syslog message.

FIG. 6 is a flow diagram that illustrates an embodiment of a method for modifying a syslog system to accept syslog messages having a particular format.

FIG. 7 is a flow diagram that illustrates a further embodiment of a method for . . .

FIG. 8 is a flow diagram that illustrates a further embodiment of a method for . . .

### DETAILED DESCRIPTION

As described above, it can be undesirable for a syslog daemon to discard syslog messages having an unfamiliar format given that the messages may be legitimate and important to network operation and security. As described below, systems and methods are described with which a syslog system can be dynamically modified so as to enable validation of syslog messages having a previously unknown or unacceptable format.

In some embodiments, incoming syslog messages are validated through comparison with one or more syslog message templates. In such a case, a syslog message will be considered valid as long as its format matches the format of at least one of the templates. When a new syslog message format is encountered that is deemed to be acceptable, the syslog system can be dynamically modified to validate messages having that format by creating a new template reflective of the new format. Once the new template has been stored, syslog messages having the new format will not be discarded and therefore will be available for consideration if and when a problem occurs.

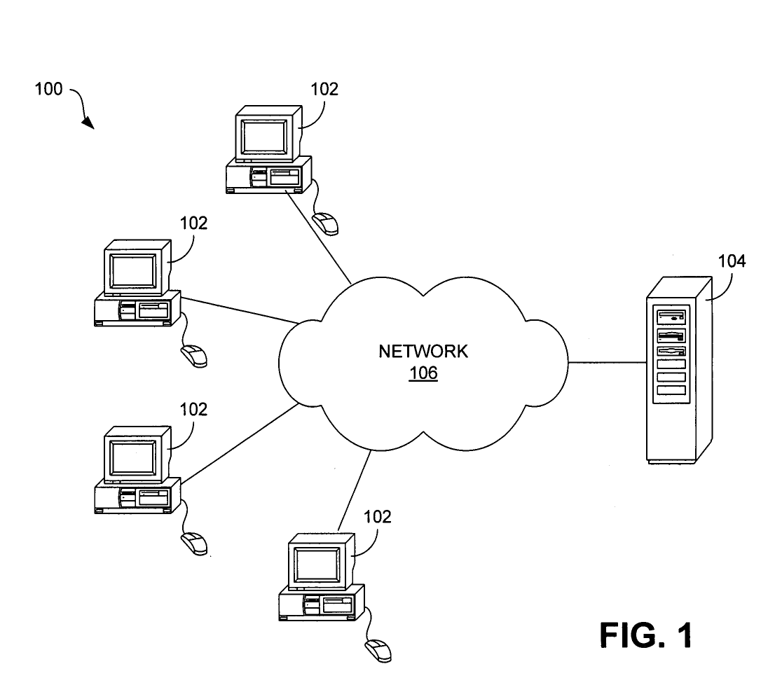

Referring now in more detail to the drawings, in which like numerals indicate corresponding parts throughout the several views, FIG. 1 illustrates an example system 100. As indicated in that figure, the system 100 generally comprises multiple client computers 102 and a server computer 104. In the embodiment of FIG. 1, the client computers 102 comprise personal computers (PCs) that are configured to communicate with the server computer 104. More particularly, the PCs can transmit syslog messages to the server computer 104 via a network 106. Although PCs are illustrated in FIG. 1 by way of example, it will be appreciated that substantially any network-enabled device connected to the network can transmit syslog messages to the server computer 104. Therefore, although PCs are illustrated in FIG. 1 as example syslog senders, many other types of devices may comprise syslog senders.

As can be appreciated from the foregoing, the server computer 104 operates as a syslog server that receives and stores syslog messages transmitted over the network 106 by syslog senders. As described in greater detail below, the server computer 104 can comprise a syslog daemon that is used to validate incoming syslog messages and store validated syslog messages.

The network 106 can comprise a single network, such as a local area network (LAN), or may comprise a collection of networks (LANs and/or wide area networks (WANs)) that are communicatively coupled to each other. In some embodiments, the network 106 may comprise part of the Internet.

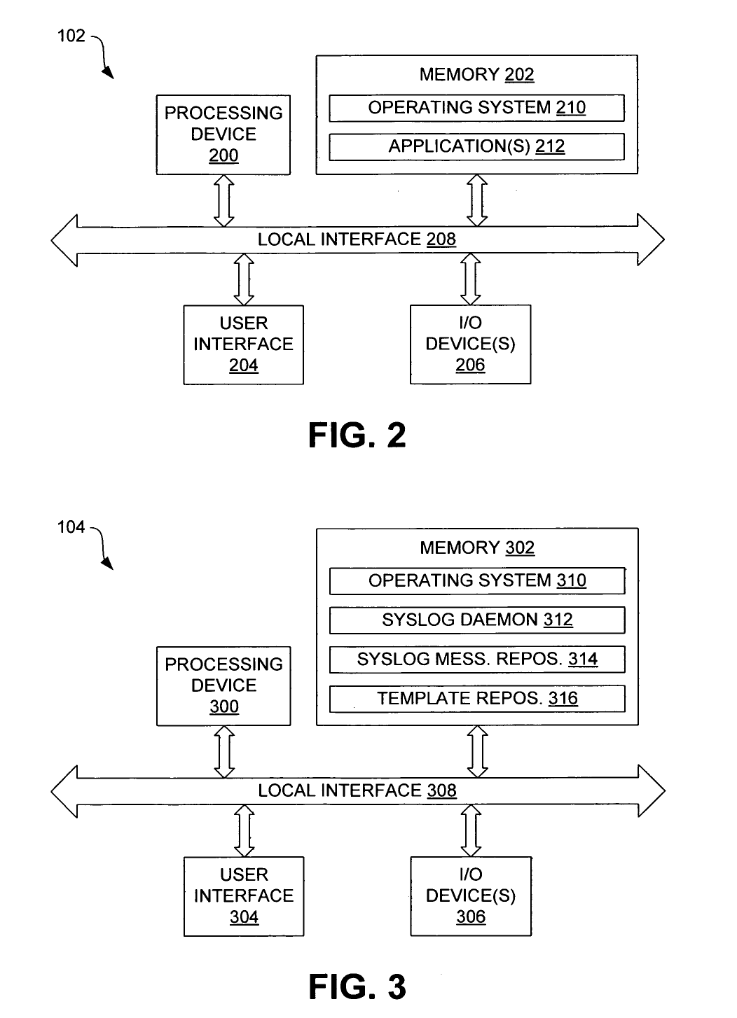

FIG. 2 is a block diagram illustrating an example architecture for one of the client computers 102. The computer 102 of FIG. 2 comprises a processing device 200, memory 202, a user interface 204, and at least one I/O device 206, each of which is connected to a local interface 208.

The processing device 200 can include a central processing unit (CPU) or an auxiliary processor among several processors associated with the computer 102, or a semiconductor based microprocessor (in the form of a microchip). The memory 202 includes any one of or a combination of volatile memory elements (e.g., RAM) and nonvolatile memory elements (e.g., hard disk, ROM, tape, etc.).

The user interface 204 comprises the components with which a user interacts with the computer 102. The user interface 204 may comprise, for example, a keyboard, mouse, and a display, such as a cathode ray tube (CRT) or liquid crystal display (LCD) monitor. The one or more I/O devices 206 are adapted to facilitate communications with other devices and may include one or more communication components such as a modulator/demodulator (e.g., modem), wireless (e.g., radio frequency (RF)) transceiver, network card, etc.

The memory 202 comprises various programs including an operating system 210 and one or more applications 212. The operating system 210 controls the execution of other programs and provides scheduling, input-output control, file and data management, memory management, and communication control and related services. The applications 212 can comprise any application that executes on the computer 102 and is capable of transmitting a syslog message to the server computer 104. Accordingly, one or more of the applications 212 can be considered to comprise syslog senders.

FIG. 3 is a block diagram illustrating an example architecture for the server computer 104 (i.e., syslog server) shown in FIG. 1. As indicated in FIG. 3, the server computer 104 comprises many of the same components as the client computer 102 shown in FIG. 2, including a processing device 300, memory 302, a user interface 304, and at least one I/O device 306, each of which is connected to a local interface 308. In some embodiments, those components have the same or similar construction and/or function of like-named components described above in relation to FIG. 2. Accordingly, a detailed discussion of the components of FIG. 3 is not presented herein.

As indicated in FIG. 3, the memory 302 of the server computer 104 comprises an operating system 310 and a syslog daemon 312. The operating system 310 controls the execution of other programs and provides scheduling, input-output control, file and data management, memory management, and communication control and related services. The syslog daemon 312 is configured to manage syslog messages that are received from syslog senders, such as the client computers 102 and/or applications 212 executing on those computers. More particularly, the syslog daemon 312 evaluates newly received syslog messages and determines which are valid and which are invalid using templates stored in a template repository 316. Valid messages are stored by the syslog daemon 312 in a syslog message repository 314 and invalid messages are discarded. Notably, a record (not shown) of invalid messages can be maintained either within memory 302 or another location so that an interested party, such as a network administrator, can identify what types of messages are being discarded by the system. Various programs (i.e. logic) have been described herein. The programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

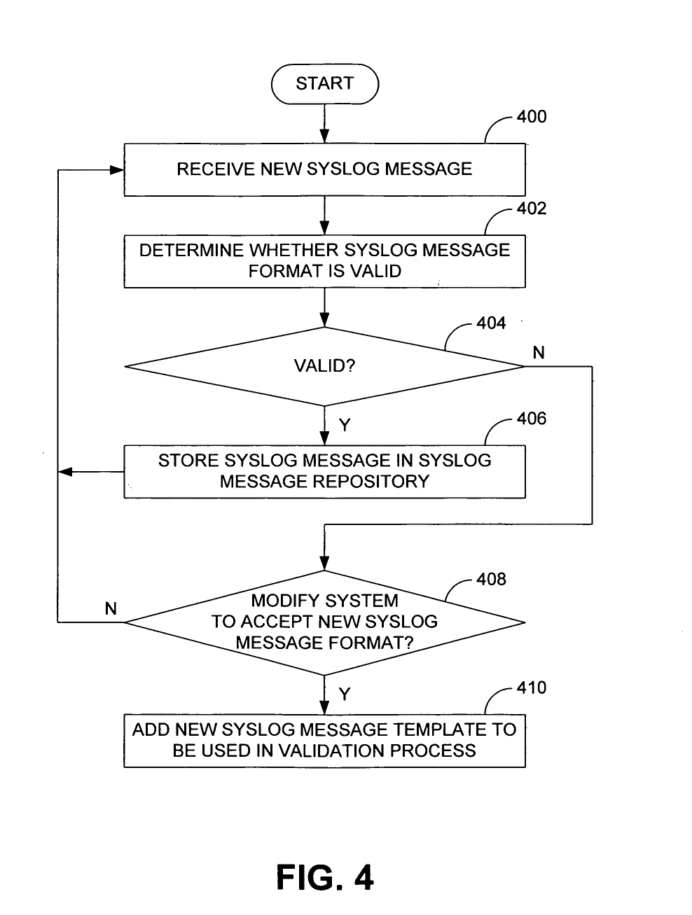

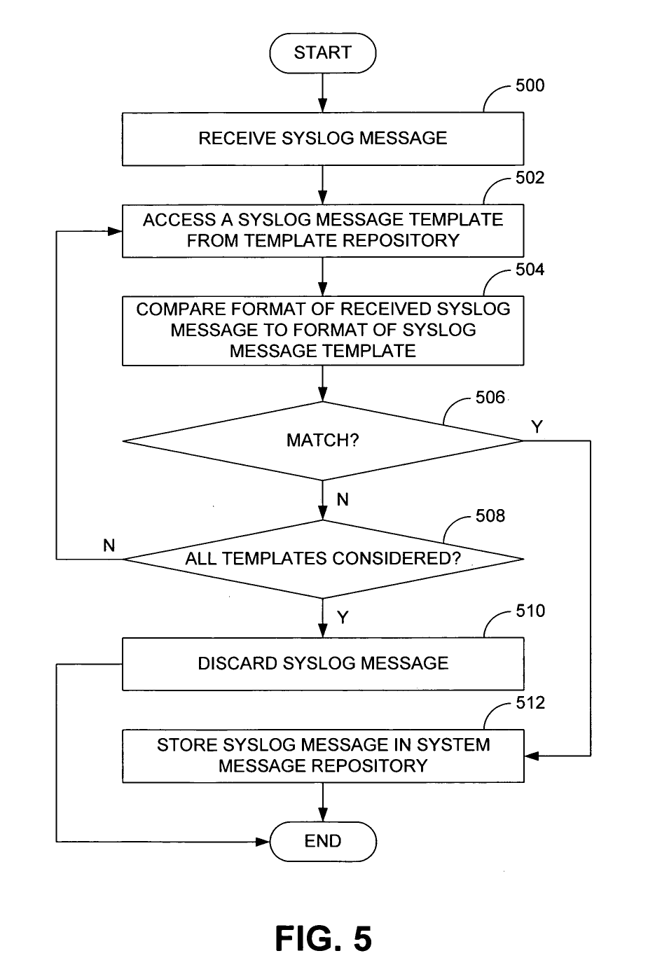

FIG. 4 illustrates an example method for managing syslog messages. Beginning with block 400, a new syslog message is received. In particular, the syslog message is received by a syslog daemon, such a daemon 312 in FIG. 3. Next, the syslog daemon determines whether the format of the syslog message is currently considered valid, as indicated in block 402. An example process for determining message validity is described in detail in relation to FIG. 5. For purposes of this example, however, it can be assumed that the format is compared with the format of a stored syslog message template to determine whether the format of the message matches the format of the template.

Turning to decision block 404, if the syslog message format is valid, the syslog message is stored in a syslog message repository, (e.g., repository 314 in FIG. 3), as indicated in block 406. At that point, flow returns to block 400 at which a further new syslog message is received. If the syslog message format is not valid, for example if the syslog message format does not match the format of the syslog message template, flow continues to decision block 408 at which it is determined whether the syslog system should be modified to accept a new syslog message format, i.e., the format of the syslog message that was received in block 400. Notably, the determination as to whether to modify the syslog system can be left solely to the discretion of a human being, such as a network administrator, or can be partially or completely automated, depending upon system configuration. In the case in which a human being is left with the discretion as to whether to allow or disallow the syslog messages of the unknown format, the decision maker can have identified the invalid message after receiving a message generated by the system that alerted the decision maker as to the rejection of the syslog message or after manually reviewing a listing of syslog messages that were invalidated by the system.

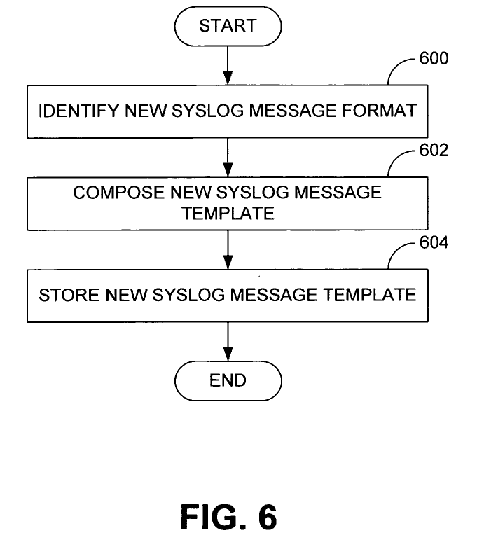

If the syslog system is not to be modified to validate messages having the newly encountered syslog message format, flow returns to block 400 at which a new syslog message is received. If, on the other hand, the syslog system is to be modified, a new syslog message template is added to the system to be used in the validation process as indicated in block 410. As described in greater detail in relation to FIG. 6, once such a new template has been added, further messages having the new syslog message format will be determined to be valid and will be stored in the syslog message repository.

FIG. 5 illustrates an example method for validating, or invalidating, a given received syslog message that can be used in the process described in relation to FIG. 4. Beginning with block 500 of FIG. 5, the syslog message is received by the syslog daemon. Once the syslog message has been received, the syslog daemon accesses a syslog message template from the syslog message template repository, as indicated in block 502.

By way of example, the syslog message template comprises a regular expression. As used herein, the term “regular expression” refers to a string of characters arranged in a format indicative of the format of a syslog message that is to be considered acceptable when making the validation determination. The regular expression therefore has the general arrangement, composition, pattern, or syntax of an actual syslog message, i.e., the real expression is a string of characters comprising the various entries or fields of an actual syslog message without specifying particular pieces of information for each of those entries or fields. Therefore, assuming an acceptable syslog message contains separate entries for facility, severity, hostname, timestamp, and message as per RFC 3164, the regular expression of a corresponding syslog message template will comprise those same entries without specifying a particular facility, severity, hostname, timestamp, or message. To take a specific example, if the timestamp of a syslog message to be accepted includes a three-letter designation of a month in which the message was transmitted, the corresponding regular expression will contain an entry that includes a three-letter designation for each month of the year and, therefore, will not specify a particular month.

Examples of an actual syslog message and a corresponding syslog message regular expression are provided below:

### Example Syslog Message:

<676> Mar 4 04:03:00 15.29.33.111 tftp: Successfully transferred file

### Example Syslog Message Regular Expression:

“(<\\d{1,3}>\\d{1,3})\\s(Jan|Feb|Mar|Apr|May|Jun|Jul|Aug|Sep|Oct|Nov|Dec)(\\s\\d{2}\\s\\s\\d{1})\\s\\d{2}:\\d{2}:\\d{2}\\s\\S{0,15}\\s.{0,31}(:|\\[\\s).*”

As can be appreciated from the above, the example syslog message regular expression has the same general configuration of the example syslog message and therefore can be used as a reference in adjudging whether a syslog message is valid. Therefore, returning to FIG. 5, the format of the received syslog message is compared to the format of the syslog message template (e.g., regular expression), as indicated in block 504.

Referring next to decision block 506, if through the comparison the format of the received syslog message matches the format of the syslog message template, flow continues down to block 512 at which the syslog message is stored in the syslog message repository. If, however, the format of the received syslog message does not match the format of the syslog message template, flow continues to decision block 508 at which it is determined whether all templates contained in the template repository have been considered. If not, flow returns to block 502 at which a different syslog message template is accessed for the purpose of comparison with the received syslog message and the process described above is repeated. Assuming, however, that each template of the template repository has been considered, meaning that there are no syslog message templates contained within the repository having a format that matches the format of the received syslog message, the received syslog message is deemed invalid and is discarded, as indicated in block 510.

Using the validation process described above in relation to FIG. 5, the syslog daemon can be configured to accept and store syslog messages having various different formats. In particular, the number of types of syslog messages that will be accepted is equal to the number of syslog message templates that are stored within the syslog message template repository. Given that validation will occur when a template having a corresponding format exists in the syslog message template repository, it is relatively simple to add new formats of syslog messages that will be accepted and stored by the syslog daemon. In particular, a new syslog message template reflective of the format of the type syslog message to be accepted can be added to the syslog message template repository. FIG. 6 provides an example of such a process.

In FIG. 6, it is assumed that syslog messages of a given format, for example an alternative format that previously was not deemed acceptable, are to be accepted (i.e., validated) in the future. As described above, the determination to accept such messages may be made by a human being. The fact that messages having that format are being rejected can be determined in a manual nature. For example, the decision to modify the syslog system can be made after the human being realizes that messages having a given format are being rejected after consulting a record or log of rejected messages. In a partially automated scenario, the human being can be alerted that messages having that format are being rejected so as to identify a potential need to modify the syslog system to accept such messages. For example, if the system determines that a relatively large number of messages having a particular format are being discarded, an alert can be automatically generated upon reaching a threshold number of messages.

Irrespective of the manner in which the decision to modify the syslog system is reached, the new syslog message format can be identified, as indicated at block 600 of FIG. 6. Next, a syslog message template having a format that corresponds to the new syslog message format is composed, as indicated in block 602. Assuming that the template is a regular expression comprising a mere text string, the template composition process is relatively simple and can be performed by most network administrators. To generate the regular expression, the new syslog message format is captured and then emulated without specifying specific pieces of information for the various entries of the message, as illustrated in the example provided above. If necessary, the network administrator can review example regular expressions from various libraries of regular expressions that are accessible online. For example, such a library exists for the Java programming language. With reference to such a library, the network administrator can quickly determine the various “rules” associated with composing regular expressions.

Next, with reference to block 604, the composed syslog message template is stored in a location that the syslog daemon will reference when conducting the message validation process. That location has been described above as the syslog message template repository. The “repository” can comprise any construct that can be accessed by the syslog daemon. In one example, the repository comprises a directory containing separate files, each file pertaining to a separate template. In another example, the repository comprises a single file having multiple entries or lines, each entry or line corresponding to a different templates. In another example, the repository having a table comprises separate entries, each entry corresponding to a separate template.

Irrespective of the nature of the syslog message template repository, once the new syslog message template is stored in a location accessible by the syslog daemon, the template can be used to validate incoming messages having a corresponding format, for example in the manner described above in relation to FIG. 5.

As can be appreciated from the foregoing, the disclosed systems and methods can be used to simplify both the message validation process and the process of modifying the syslog system to accept newly discovered syslog message formats. Given that the system can be adjusted to accept alternative message formats by simply composing a new regular expression and storing it in a location at which it will be consulted by the syslog daemon, a high level of programming skill is not required, as may be the case when a validation algorithm is used to validate incoming syslog messages. Therefore, it is relatively quick and easy for network administrators to extend the acceptance of syslog messages, thereby reducing the need for reliance on outside technical assistance personnel.

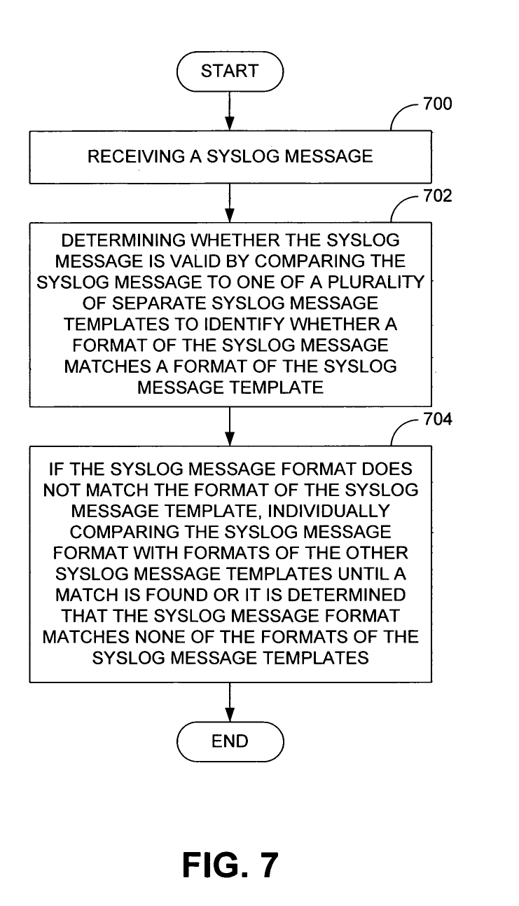

FIG. 7 illustrates an example method for managing syslog messages. The method of FIG. 7 comprises receiving a syslog message (700), determining whether the syslog message is valid by comparing the syslog message to one of a plurality of separate syslog message templates to identify whether a format of the syslog message matches a format of the syslog message template (702), and if the syslog message format does not match the format of the syslog message template, individually comparing the syslog message format with formats of the other syslog message templates until a match is found or it is determined that the syslog message format matches none of the formats of the syslog message templates (704).

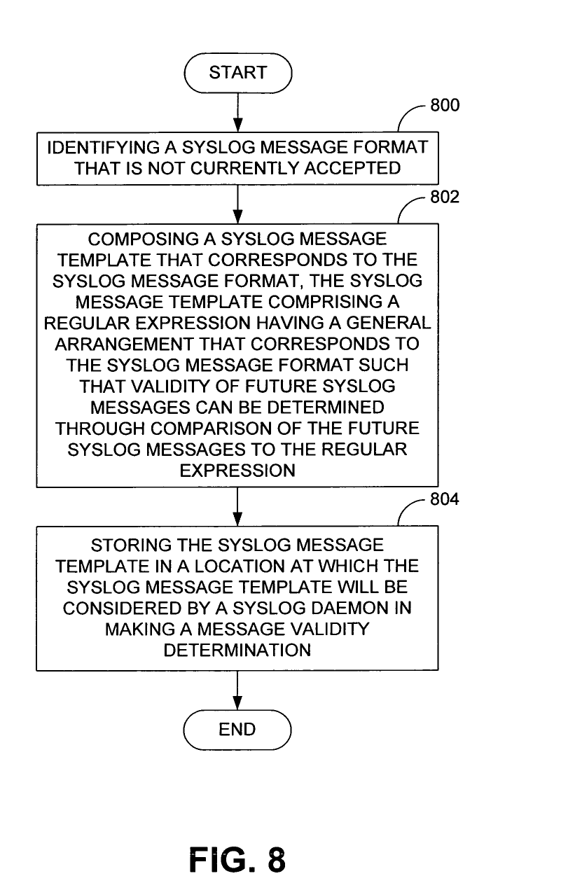

FIG. 8 illustrates a further example method for managing syslog messages. The method of FIG. 8 comprises identifying a syslog message format that is not currently accepted (800), composing a syslog message template that corresponds to the syslog message format, the syslog message template comprising a regular expression having a general arrangement the corresponds to the syslog message format such that validity of future syslog messages can be determined through comparison of the future syslog messages to the regular expression (802), and storing the syslog message template in a location at which the syslog message template will be considered by a syslog daemon in making a message validity determination (804).

Although particular embodiments of systems and methods have been described in the foregoing, those embodiments are mere examples of the disclosed systems and methods. Therefore, other embodiments are possible and are considered to fall within the scope of the present disclosure.

The following are claimed:

1. A method for managing syslog messages, the method comprising:
receiving a syslog message;
determining whether the syslog message is valid by comparing the syslog message to one of a plurality of separate syslog message templates to identify whether a format of the syslog message matches a format of the syslog message template; and
if the syslog message format does not match the format of the syslog message template, individually comparing the syslog message format with formats of the other syslog message templates until a match is found or it is determined that the syslog message format matches none of the formats of the syslog message templates.

2. The method of claim 1, wherein comparing the syslog message to one of a plurality of discrete syslog message templates comprises comparing the syslog message to one of a plurality of regular expressions each comprising the general arrangement of an acceptable syslog message.

3. The method of claim 1, further comprising, if a match is found, storing the received syslog message in a syslog message repository.

4. The method of claim 1, further comprising, if no match is found, discarding the received syslog message.

5. A computer-readable medium that stores a system for managing syslog messages, the system comprising:
logic configured to determine whether the syslog message is valid by comparing the syslog message to one of a plurality of separate syslog message templates to identify whether a format of the syslog message matches a format of the syslog message template; and
logic configured to, if the syslog message format does not match the format of the syslog message template, individually compare the syslog message format with formats of the other syslog message templates until a match is found or it is determined that the syslog message format matches none of the formats of the syslog message templates.

6. The computer-readable medium of claim 5, wherein the logic configured to determine comprises logic configured to compare the syslog message to one of a plurality of regular expressions each comprising the general arrangement of an acceptable syslog message.

7. The computer-readable medium of claim 5, further comprising logic configured to, if a match is found, store the received syslog message in a syslog message repository.

8. The computer-readable medium of claim 5, further comprising logic configured to, if no match is found, discard the received syslog message.

9. A method for managing syslog messages, the method comprising:
identifying a syslog message format that is not currently accepted;
composing a syslog message template that corresponds to the syslog message format, the syslog message template comprising a regular expression having a general arrangement the corresponds to the syslog message format such that validity of future syslog messages can be determined through comparison of the future syslog messages to the regular expression; and
storing the syslog message template in a location at which the syslog message template will be considered by a syslog daemon in making a message validity determination.

10. The method of claim 9, wherein identifying a syslog message format comprises identifying the syslog message format from a syslog message that was previously determined to be invalid.

11. The method of claim 9, wherein identifying a syslog message format comprises identifying the syslog message format from a syslog message that was previously discarded.

12. The method of claim 9, wherein composing a syslog message template comprises composing a regular expression consisting of a string of characters arranged in a format that is indicative of the syslog message format.

13. The method of claim 9, wherein composing a syslog message template comprises composing a regular expression comprising a string of characters that form various entries or fields that a valid syslog message would contain.

14. The method of claim 9, wherein storing the syslog message template comprises storing the syslog message template in a syslog message template repository.

15. The method of claim 14, wherein storing the syslog message template in a syslog message template repository comprises storing an independent file containing the regular expression in a directory.

16. The method of claim 14, wherein storing the syslog message template in a syslog message template repository comprises storing the regular expression in a single file comprising separate entries for multiple regular expressions.

17. The method of claim 14, wherein storing the syslog message template in a syslog message template repository comprises storing the regular expression in a table comprising separate entries for multiple regular expressions.

18. A system for managing syslog messages, the system comprising:
means for identifying a syslog message format that is not currently accepted;
means for composing a syslog message template that corresponds to the syslog message format, the syslog message template comprising a regular expression having a general arrangement the corresponds to the syslog message format such that validity of future syslog messages can be determined through comparison of the future syslog messages to the regular expression; and
means for storing the syslog message template in a location at which the syslog message template will be considered by a syslog daemon in making a message validity determination.

19. The system of claim 18, wherein the means for composing a syslog message template comprise means for composing a regular expression consisting of a string of characters arranged in a format that is indicating of the syslog message format.

20. The system of claim 18, wherein the means for composing a syslog message template comprise the means for composing a regular expression comprising a string of characters that form various entries or fields that a valid syslog message would contain.

21. The system of claim 18, wherein the means for storing the syslog message template comprise a template repository.

22. The system of claim 21, wherein the repository comprises a directory in which independent files containing separate regular expressions are stored.

23. The system of claim 21, wherein the repository comprises a file that contains separate entries for multiple regular expressions.

24. The system of claim 21, wherein the repository comprises a table containing separate entries for multiple regular expressions.

25. A computer comprising:
a processing device; and
memory including a syslog daemon, a syslog message repository, and a syslog message template repository, the syslog daemon being configured to receive syslog messages, determine whether the syslog messages are valid, store valid syslog messages within the syslog message repository, and discard invalid syslog messages, wherein the syslog daemon determines whether the syslog messages are valid by comparing the syslog message to one or more of a plurality of separate syslog message templates stored in the syslog message template repository to identify whether formats of the syslog messages match formats of the syslog message templates.

26. The computer of claim 25, wherein the syslog message templates comprise regular expressions each consisting of a string of characters arranged in a format that is indicative of the syslog message format.

27. The computer of claim 25, wherein the syslog message templates comprise regular expressions each comprising a string of characters that form various entries or fields that a valid syslog message would contain.
